(19) United States
(12) Patent Application Publication
(10) Pub. No.: US 2026/0094436 A1
(43) Pub. Date: Apr. 2, 2026

(54) AUDIO-VISUAL ANALYTIC FOR OBJECT RENDERING IN CAPTURE

(71) Applicant: DOLBY LABORATORIES LICENSING CORPORATION

(72) Inventors: Jundai Sun, Beijing (CN); Andrea Fanelli, Seattle, WA (US); Zhiwei Shuang, Shuang (CN)

(73) Assignee: DOLBY LABORATORIES LICENSING CORPORATION, (US)

(21) Appl. No.: 19/110,641

(22) PCT Filed: Sep. 12, 2023
(86) PCT No.: PCT/US2023/073930

§ 371 Date: Mar. 11, 2025

Related U.S. Application Data
(60) Provisional application No. 63/449,726, filed on Mar. 3, 2023.

(30) Foreign Application Priority Data
Sep. 13, 2022 (WO) PCT/CN2022/118437

(51) Int. Cl. G06V 20/40; G06F 16/65; G06F 16/75; G06V 10/56

(52) U.S. Cl. CPC G06V 20/41; G06F 16/65; G06F 16/75; G06V 10/56

(57) ABSTRACT

A system and method for the generation of automatic audio-visual analytics for object rendering in capture. One example provides a method of processing audiovisual content. The method includes receiving content including a plurality of audio frames and a plurality of video frames, classifying each of the plurality of audio frames into a plurality of audio classifications, and classifying each of the plurality of video frames into a plurality of video classifications. The method includes processing the plurality of audio frames based on the respective audio classifications and processing the plurality of video frames based on the respective video classifications. Each audio classification is processed with a different audio processing operation, and each video classification is processed with a different video processing operation. The method includes generating an audio/video representation of the content by merging the processed plurality of audio frames and the processed plurality of video frames.

### 1. CROSS-REFERENCE TO RELATED APPLICATIONS

This application claims the benefit of priority from PCT Patent Application Publication No. PCT/CN2022/118437, filed Sep. 13, 2022, and U.S. Provisional Patent Application No. 63/449,726 filed Mar. 3, 2023, which is hereby incorporated by reference in its entirety.

### 2. FIELD OF THE DISCLOSURE

Various example embodiments relate generally to media processing of multimedia content. In particular, example embodiments are directed to a system, method, or computer program product configured for the generation of automatic audio-visual analytics for processing and rendering.

### BRIEF SUMMARY OF SOME SPECIFIC EMBODIMENTS

Disclosed herein are various embodiments for rendering objects captured within audio-visual data. An audiovisual piece of content is split into visual frames (for example, image frames, video frames) and audio frames. Audio frames are analyzed to identify audio objects within the audio frames. Visual frames are analyzed to identify visual objects within the visual frames. The audio objects and visual objects are classified based on the detected objects and scenes. Classifications may indicate, for example, whether the audiovisual content is indoors or outdoors, whether captured content includes sports, people, landscapes, and furthermore may indicate particular object types, and so on. The audio frames and the visual frames are separately processed using the detected objects and classifications, and are recombined to create a final audiovisual output.

Examples, instances, and aspects of the disclosure provide a method of classifying and categorizing objects based on the object's contribution to the intelligibility, immersiveness, and spaciousness of the overall audio. By classifying and categorizing both audio frames and visual frames, the audio and visual aspects of an audiovisual piece of content are capable of being separately processed, increasing the quality of the final audiovisual output.

According to an example embodiment, provided is a method of processing audiovisual content. The method includes receiving content including a plurality of audio frames and a plurality of video frames, classifying each of the plurality of audio frames into a plurality of audio classifications, and classifying each of the plurality of video frames into a plurality of video classifications. The method includes processing the plurality of audio frames based on the respective audio classifications and processing the plurality of video frames based on the respective video classifications. Each audio classification is processed with a different audio processing operation, and each video classification is processed with a different video processing operation. The method includes generating an audio/video representation of the content by merging the processed plurality of audio frames and the processed plurality of video frames.

According to another example embodiment, provided is a non-transitory computer-readable medium storing instructions that, when executed by an electronic processor, cause the electronic processor to perform operations comprising receiving content including a plurality of audio frames and a plurality of video frames, classifying each of the plurality of audio frames into a plurality of audio classifications, and classifying each of the plurality of video frames into a plurality of video classifications. The instructions include processing the plurality of audio frames based on the respective audio classifications and processing the plurality of video frames based on the respective video classifications. Each audio classification is processed with a different audio processing operation, and each video classification is processed with a different video processing operation. The instructions include generating an audio/video representation of the content by merging the processed plurality of audio frames and the processed plurality of video frames.

According to yet another example embodiment, provided is a video system for processing audiovisual content. The system includes a processor to perform processing of audiovisual content. The processor is configured to receive content including a plurality of audio frames and a plurality of video frames, classify each of the plurality of audio frames into a plurality of audio classifications, and classify each of the plurality of video frames into a plurality of video classifications. The processor is configured to process the plurality of audio frames based on the respective audio classifications and process the plurality of video frames based on the respective video classifications. Each audio classification is processed with a different audio processing operation, and each video classification is processed with a different video processing operation. The processor is configured to generate an audio/video representation of the content by merging the processed plurality of audio frames and the processed plurality of video frames.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 depicts an example process for a video/image delivery pipeline.

FIG. 2 depicts an example audio-visual analytic-based rendering system.

FIG. 3 depicts an example visual analytic system.

FIG. 4 depicts an example video frame including noise.

FIG. 5 depicts the example video frame of FIG. 4 after resizing.

FIG. 6 depicts a block diagram of an example method for detecting a scene change.

FIGS. 7A-7C depict an example 3 by 3 neighborhood of pixels.

FIG. 8 depicts another block diagram of an example method for detecting a scene change.

FIG. 9 depicts a block diagram of an example method for processing audiovisual content.

### DETAILED DESCRIPTION

This disclosure and aspects thereof can be embodied in various forms, including hardware, devices or circuits controlled by computer-implemented methods, computer program products, computer systems and networks, user interfaces, and application programming interfaces; as well as hardware-implemented methods, signal processing circuits, memory arrays, application specific integrated circuits (ASICs), field programmable gate arrays (FPGAs), and the like. The foregoing is intended solely to give a general idea of various aspects of the present disclosure and does not limit the scope of the disclosure in any way.

### Example Video/Image Delivery Pipeline

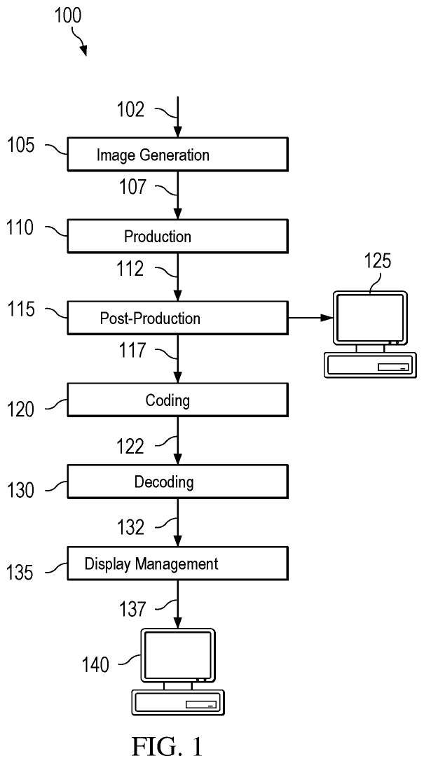

FIG. 1 depicts an example process of a video delivery pipeline 100, showing various stages from video/image capture to video/image-content display according to an embodiment. A sequence of video/image frames 102 may be captured or generated using an image-generation block 105. The frames 102 may be digitally captured (e.g., by a digital camera, by a phone camera, etc.) or generated by a computer (e.g., using computer animation) to provide video and/or image data 107. Audio data may also be provided as part of data 107 and associated with the video/image data. Alternatively, the frames 102 may be captured on film by a film camera. Then, the film may be translated into a digital format to provide the video/image data 107.

Audio data may include channel-based audio that assigns sound sources to particular channels (e.g., stereo, 5.1, 7.1, or the like), object-based audio that may assign sound objects to particular channels, and any associated metadata. For example, an audio object may include one or more audio signals (e.g., a stream of audio data or data encoding audio essence, also referred to herein as “audio object signals”) and associated metadata. The metadata describes one or more characteristics of the audio signals (e.g., informational metadata) or indicates how the audio signals should be processed by downstream processes such as rendering (e.g., control metadata).

In some embodiments, the metadata includes audio object position data, audio object size data, audio object gain data, audio object trajectory data, content type data (e.g., dialog, effects, etc.), rendering constraint data, and the like. Metadata corresponding to a discrete audio source among audio signals, which may also be referred to as a parametric source description, includes spatial audio descriptions for respective sources (e.g., source position/3D coordinates and source size).

Some audio objects may be static, whereas others may have time-varying metadata. Time-varying audio objects may move, may change size, and/or may have other properties that change over time.

When audio objects are monitored or played back in a reproduction environment, the audio objects may be rendered according to the positional metadata using the reproduction speakers that are present in the reproduction environment, rather than being output to a predetermined physical channel, as is the case with traditional channel-based systems such as Dolby 5.1 and Dolby 7.1.

While some metadata associated with audio objects may be received alongside the audio data, further metadata may be generated during audio-visual analysis processes described herein.

In a production phase 110, the data 107 may be processed by a processor at the production phase 110 to provide a viewable video/image production stream 112. The data of the video/image production stream 112 may be provided to a processor (or one or more processors, such as a central processing unit, CPU) at a post-production block 115 for post-production editing. The post-production editing may be performed by a user of the video delivery pipeline 100, such as a creator that captured the frames 102. The post-production editing of the block 115 may include, e.g., adjusting or modifying colors or brightness in particular areas of an image to enhance the image quality or achieve a particular appearance for the image in accordance with the video creator's creative intent. This part of post-production editing is sometimes referred to as “color timing” or “color grading.” Other editing (e.g., scene selection and sequencing, image cropping, addition of computer-generated visual special effects, removal of artifacts, etc.) may be performed at the block 115 to yield a “final” version 117 of the production for distribution. In some examples, operations performed at the block 115 include detecting and classifying objects within the data 107. During the post-production editing 115, video and/or images may be viewed on a reference display 125.

Following the post-production 115, the data of the final version 117 may be delivered to a coding block 120 for being further delivered downstream to decoding and playback devices, such as television sets, set-top boxes, movie theaters, and the like. In some embodiments, the coding block 120 may include audio and video encoders, such as those defined by the ATSC, DVB, DVD, Blu-Ray, and other delivery formats, to generate a coded bitstream 122. In a receiver, the coded bitstream 122 is decoded by a decoding unit 130 to generate a corresponding decoded signal 132 representing a copy or a close approximation of the signal 117. The receiver may be attached to a target display 140 that may have somewhat or completely different characteristics than the reference display 125. In such cases, a display management (DM) block 135 may be used to map the decoded signal 132 to the characteristics of the target display 140 by generating a display-mapped signal 137. Depending on the embodiment, the decoding unit 130 and display management block 135 may include individual processors or may be based on a single integrated processing unit.

A codec used in the coding block 120 and/or the decoding block 130 enables video/image data processing and compression/decompression. The compression is used in the coding block 120 to make the corresponding file(s) or stream(s) smaller. The decoding process carried out by the decoding block 130 typically includes decompressing the received video/image data file(s) or streams(s) into a form usable for playback and/or further editing. Example coding/decoding operations that can be used in the coding block 120 and the decoding unit 130 according to various embodiments are described in more details below.

### Audio-Visual Rendering System

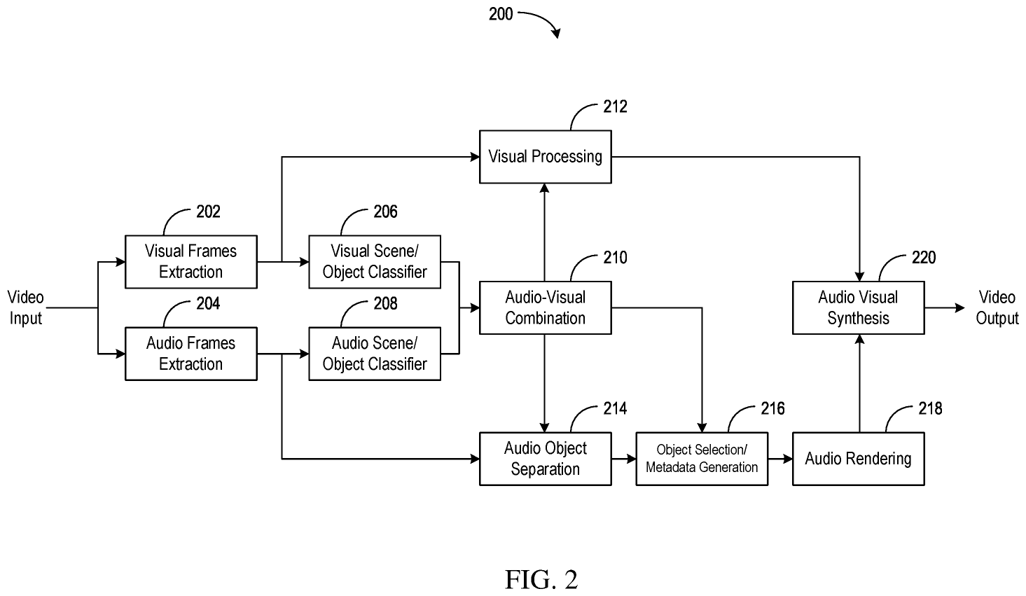

FIG. 2 illustrates a block diagram of an audio-visual analytic based object rendering system 200. The operations of the described audio-visual analytic based object rendering system 200 may be performed by an electronic processor of the post-production block 115. An audiovisual video input is split into visual frames and audio frames by visual frames extraction block 202 and audio frames extraction block 204, respectively. Visual frames as referred to herein include image frames or video frames captured by a camera. Audio frames as referred to herein includes audio data captured by a microphone that is associated with the visual frames (for example, captured contemporaneously with the visual frames).

The visual frames are provided to a visual scene/object classifier block 206 for visual scene and/or object classification. The audio frames are provided to an audio scene/object classifier block 208 for audio scene and/or object classification.

Scene classes may contain several different classifiers, each classifier having a different purpose. For example, one scene classifier may be used to analyze the captured location, such as an outdoor location, an indoor location, or a type of transportation. Another scene classifier may be used to distinguish the captured content type, such as sports, food, landscapes, people, and the like. Classifiers may also perform object localization and segmentation. Output classes resulting from classification for the audio and visual classifiers may be the same classifiers, different classifiers, or related classifiers. For example, for a bird chirping object, the audio class may be “bird chirping”, but the visual class may be “tree”. “birds”, “bird cage”, or the like.

In some instances, in addition to the classifications, the audio objects are assigned into four main categories based on the perceptual importance of the audio. The categories may include “essential objects” (e.g., a first category), “high importance objects” (e.g., a second category), “important objects” (e.g., a third category), and “low importance objects” (e.g., a fourth category). Objects assigned as “essential objects” represent objects that contribute on the intelligibility and spaciousness of the audio data. For example, detected speech may be classified as an “essential object.” as well as any object providing height information that may bring an increased feeling of spaciousness to the audio. Objects assigned as “high importance objects” include non-speech sounds that contribute to audio immersiveness, such as animal sounds and directional objects with clear time-frequency patterns. Objects assigned as “important objects” include background sounds that contain environmental information of the scene. These objects may be attenuated to increase speech intelligibility, with only a small impact on sound scene immersiveness. Objects assigned as “low importance objects” include ambient sounds that may be highly attenuated to improve intelligibility of the audio. Accordingly, while audio objects in one category (e.g., “important objects”) may be attenuated at a first level, audio objects in a second category (e.g., “low importance objects”) may be attenuated at a second level greater than the first level, or vice versa. While particular categories are provided, these categories are merely examples. Fewer or more categories may be provided to provide an order of importance for the classified audio objects.

In some implementations, classification of objects is performed automatically by the electronic processor. For example, the electronic processor may implement a machine-learned model configured to receive audio data and classify the audio data. Each classification may by assigned a particular category level that the electronic processor automatically associates with the audio object. For example, when the electronic processor detects that an audio component of the audio data is “speech”, the electronic processor classifies the audio object as speech and automatically categorizes the audio object as an “essential object.” In another implementation, the electronic processor receives inputs from an editor of the audio frames indicating classifications and categorizations of the audio frames.

The visual output classes and the audio output classes are combined at audio-visual combination block 210. The combination of the visual output classes and the audio output classes may be deep-learning based, rule-based, or the like. The combined audio-visual information is used as contextual information for further audio and visual processing, described below in more detail. The combined audio-visual information, as well as the original visual frames, are provided to visual processing block 212 for visual processing.

The combined audio-visual information, as well as the original audio frames, are provided to an audio object separation block 214. The audio object separation block 214 separates the objects classified by the audio scene/object classifier block 208 from the original audio frames. The separated audio objects, as well as the combined audio-visual information, are provided to object selection/metadata generation block 216. The object selection/metadata generation block 216 generates metadata describing the different audio objects. Audio rendering block 218 renders the audio objects.

The category of the audio objects may impact the processing of audio frames at the audio object separation block 214, object selection/metadata generation block 216, and/or the audio rendering block 218. For example, audio data may be assigned to particular speakers based on their categorization. Audio data associated with “high importance objects” may be widened or narrowed to increase spaciousness. Audio data associated with “low importance objects” may be suppressed to improve intelligibility of the overall audio while simultaneously preserving audio objects of greater importance.

The processed video from the visual processing block 212 and the rendered audio from the audio rendering block 218 are provided to an audio visual synthesis block 220. The audio visual synthesis block 220 combines the rendered audio and the processed visual to generate a video output.

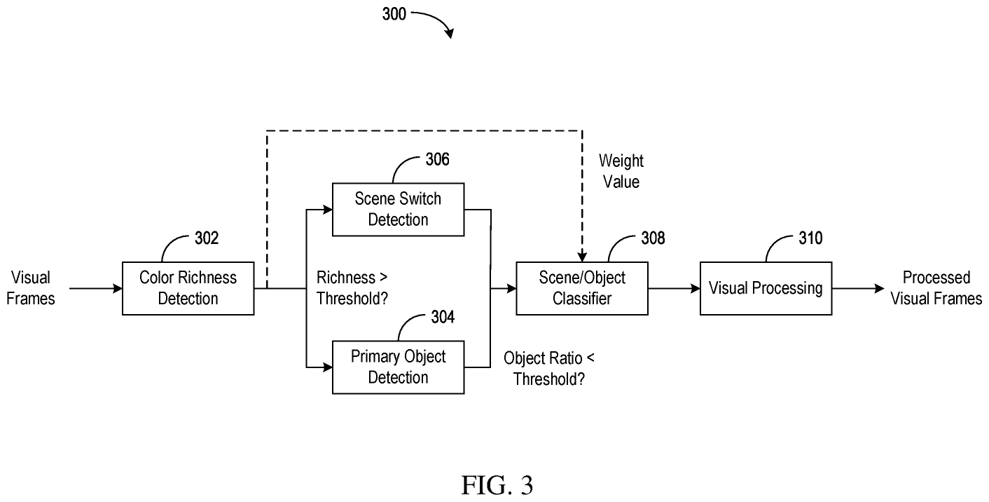

FIG. 3 illustrates a block diagram of an example visual analytic system 300. The operations described with respect to the visual analytic system 300 may be performed by the visual scene/object classifier block 206, the audio-visual combination block 210, the visual processing block 212, or a combination thereof.

The visual frames from the visual frames extraction block 202 are received by a color richness detection block 302. The color richness detection block 302 is configured to filter received video data and remove frames containing only a single color or remove frames whose color richness is lower than a set threshold. In this manner, the color richness detection block 302 removes frames that are captured when, for example, the camera lens is blocked or when the camera is too close to an object, resulting in environment or object contour information loss.

In one example of detecting color distance within a visual frame, the color distance between two RGB pixels is calculated according to Equation 1:

$$D ( {p}_{1} , {p}_{2} ) = \sqrt{{( {R}_{2} - {R}_{1} )}^{2} + {( {G}_{2} - {G}_{1} )}^{2} + {( {B}_{2} - {B}_{1} )}^{2}} \qquad [ Equation 1 ]$$

where R, G, B is the value between 0 and 255 of a red, green, and blue color channel, respectively. To simplify Equation 1, the terms may be redefined as:

$$Δ R = {( {R}_{2} - {R}_{1} )}^{2}$$

$$Δ G = {( {G}_{2} - {G}_{1} )}^{2}$$

$$Δ B = {( {B}_{2} - {B}_{1} )}^{2}$$

As human beings have different sensitivity to different RGB color values, different color components may be weighted differently. Accordingly, Equation 1 may be rewritten as Equation 2:

$$D ( {p}_{1} , {p}_{2} ) = \sqrt{{w}_{R} * ΔR + {w}_{G} * ΔG + {w}_{B} * Δ B} \qquad [ Equation 2 ]$$

In one implementation, the weighted values are w_{R}=2, w_{G}=4, and w_{B}=3, as people are more sensitive to changes in the green color channel and less sensitive to changes in the red color channel. In another implementation, w_{R}, w_{G}, and we are modified based on different color types. For example, considering a situation where the weighted values are defined as:

$$\overline{R} = \frac{{R}_{1} + {R}_{2}}{2} , {w}_{R} = 2 + \frac{\overline{R}}{256} , {w}_{G} = 4 , and {w}_{B} = 2 + \frac{255 - \overline{R}}{256}$$

then Equation 2 is written as Equation 3:

$$D ( {p}_{1} , {p}_{2} ) = \sqrt{( 2 + \frac{\overline{R}}{256} ) * Δ R + 4 * Δ G + ( 2 + \frac{255 - \overline{R}}{256} ) * Δ B} \qquad [ Equation 3 ]$$

In Equation 4, the green color channel has a fixed weight, while the red and blue color channels have a dynamic weight based on the value of the red color channel. For example, when the red color channel value is close to 255, the red color channel gets the largest weight (w_{R}=˜3), and when the red color channel value is close to 0, the blue color channel gets the largest weight (w_{B}=˜3).

In some instances, computing the weighted function for all pixels in a visual frame is highly computationally demanding. Accordingly, to reduce the computational demand, the color distance may be computed over a limited set of dominant colors. Statistical analysis may be performed on the image to compute the most represented colors in the image. In this example, the color richness of a visual frame is obtained by Equation 4:

$$cr = \frac{{\sum }_{{p}_{1} ∈ τ {p}_{2} ∈ τ and {p}_{1} \neq {p}_{2}} D ( {p}_{1} , {p}_{2} )}{N * ( N - 1 )} \qquad [ Equation 4 ]$$

where N is the number of most represented colors and t is a RGB vector of these colors, provided by Equation 5:

$$τ = [ {RGB}_{1} , {RGB}_{2} , … , {RGB}_{N} ] \qquad [ Equation 5 ]$$

when cr<100, the visual frame contains small color information.

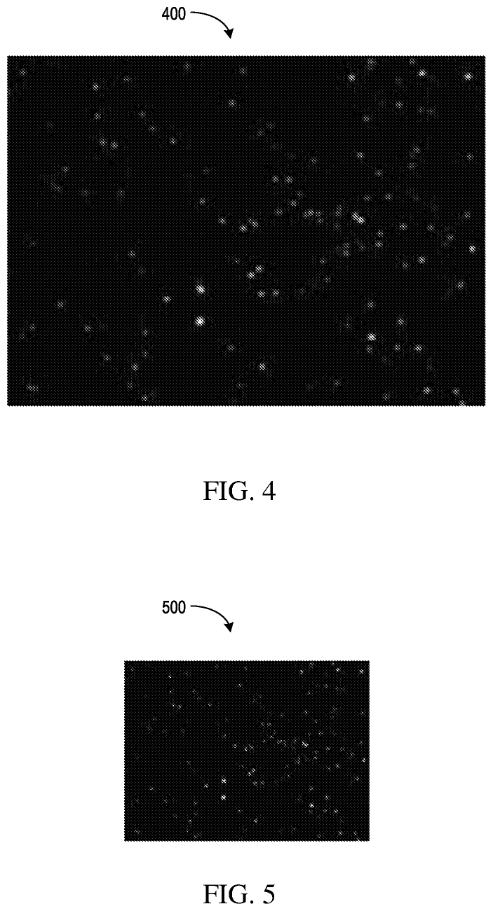

In instances where a visual frame is characterized by noise, the most represented color may be erroneously identified. For example, FIG. 4 provides an example of a video frame 400 with scatter color (indicated by white dots). The video frame has a black background selected as the most represented color. The video frame 400 has a cr value of approximately 150 due to the white spots, even though the video frame 400 has an absence of color richness. To overcome this error, the video frame 400 may be resized to a small resolution, shown as video frame 500 in FIG. 5. The smaller resolution reduces the impact of noise. The video frame 500 has a cr value of approximately 43, and frames with noise are effectively discarded. The output of the color richness detection block 302 may be an indication of whether the color richness of the visual frame cr is greater than or equal to a color richness threshold.

Returning to FIG. 3, the output of the color richness detection block 302 is provided to a primary object detection block 304 and a scene switch detection block 306. The primary object detection block 304 is configured to identify the location of primary objects of interest within the visual frames. For example, a face and/or body detection method may be performed to segment each person within the visual frame, estimate the location of each person within the image coordinate system of the visual frames, the orientation of a face to a camera reference system, the distance of the face from the camera, and the like. Primary objects are not limited merely to faces and bodies, and may also include objects such as animals, plants, buildings, or other subjects of a video frame. The primary object detection block 304 outputs an indication of the primary object and data associated with the primary object.

In the example where the primary object is a person's head, the detected head location and head pose may be used as inputs for audio processing. For example, the size of a face in the visual frame may be used to control the volume of the audio object associated to that face in the audio mix (e.g., audio associated with the person's speech). Should the face get closer to the camera in a second visual frame, the volume of the associated audio object is increased for the second visual frame. Should the face get further from the camera in the second visual frame, the volume of the associated audio object is decreased for the second visual frame. In some instances, the location of the face within the visual frame is referred to when spatializing the associated audio object. Face orientation may also be referred to for speech spatialization and reverberation. This concept may be applied to other video objects. As video objects move within video from frame to frame, the image coordinates of the video object are used to spatialize the corresponding audio object.

The scene switch detection block 306 determines changes in the object of interest (e.g., a scene change) from frame to frame. For example, a first visual frame may have a first object of interest (e.g., a person), and a second visual frame may have second object of interest (e.g., an animal). The scene switch detection block 306 outputs an indication of a change in the object of interest.

Three example scene change detection algorithms include gray-value based, edge contour based, and motion based. A gray-value based scene detection algorithm refers to the difference between the gray value of the reference frame image and the current frame to judge whether a scene change occurred. For example, the difference between the gray histogram of two frames is compared. The gray-value based scene detection algorithm has a relatively low computational complexity, but may experience errors when video objects are in motion between frames. A scene detection method based on edge contour compares the edge contours of the corresponding object between current and reference frames. This algorithm effectively detects soft handoffs such as ablation, fade in, and fade out. However, for abrupt scene handoff detection, there is no clear advantage over the gray-value based detection method, and complexity is increased compared to the gray-value based detection method. Motion-based scene change detection algorithms detect the discontinuity of video object motion before and after the scene change. The mean value of the residual error of motion estimation is used as the decision criteria for scene switching. However, reliable motion-based scene switching algorithms often have a high computation complexity.

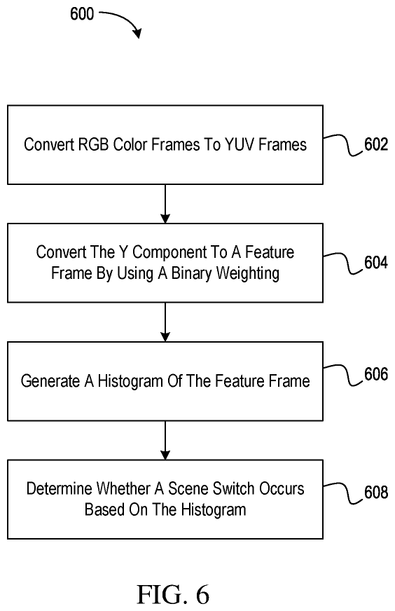

To alleviate these issues, embodiments described herein provide a hybrid scene change detection algorithm that uses the luminance (Y), chrominance (U), and chroma (V) of visual frames. FIG. 6 provides an example method 600 for detecting a scene change that is performed at scene switch detection block 306. At step 602, the method 600 includes converting RGB color frames to YUV frames.

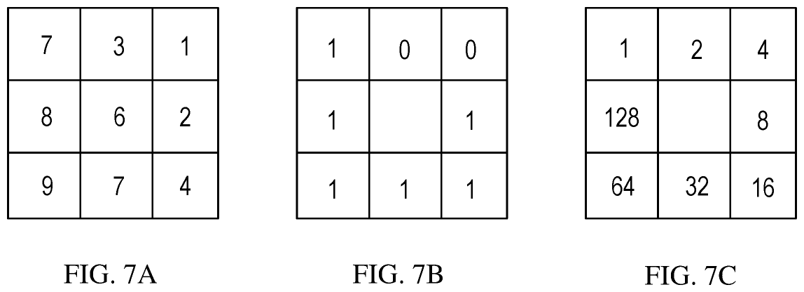

At step 604, the method 600 includes converting the Y component to a feature frame by using a binary weighting. For example, FIG. 7A illustrates an example 3*3 neighborhood pixel centered at c(x,y). The position of each neighboring pixel is “p” and its corresponding value is denoted as g(p). In FIG. 7A, the position p of each pixel is labeled from 0 to 7 in clockwise. That is, g(0)=7, g(1)=3, g(2)=1, g(3)=2, g(4)=4, g(5)=7, g(6)=9, and g(7)=8. FIG. 7B illustrates a binary map obtained by comparing g(p) and g(c). FIG. 7C illustrates a decimal value of each neighborhood pixel. The binary map of FIG. 7B is obtained according to Equation 6:

$$\hat{g} ( c ) = {\sum }_{p = 0}^{7} B ( p ) * {2}^{p} \qquad [ Equation 6 ]$$

$$where B ( p ) = \{ \begin{matrix}1 , g ( p ) > g ( c ) \\ 0 , g ( p ) < g ( c )\end{matrix} .$$

At step 606, the method 600 includes generating a histogram of the feature frame. For example, Equation 7 provides for calculating the absolute sum difference between a current frame t and a previous frame t−1.

$${swd}_{t , t - 1}^{1} = {\sum }_{i = 0}^{255} \vert {H}_{t} - {H}_{t - 1} \vert \qquad [ Equation 7 ]$$

where Hₜ is the histogram value.

At step 608, the method 600 includes determining whether a scene change occurs based on the histogram. For example, a threshold is then set for detecting the scene change, as provided by Equation 8:

$${C}_{1} ( t ) = \{ \begin{matrix}1 , {swd}_{t - 1}^{1} > {th}_{1} \\ 0 , otherwise\end{matrix} \qquad [ Equation 8 ]$$

For the first frame, C₁(t) may be set to 1. The value C₁(t) may be the output of the scene switch detection block 306. While the method 600 is described as calculating the difference between the current frame and a previous frame, the method 600 may instead calculate the difference between the current frame and a future frame.

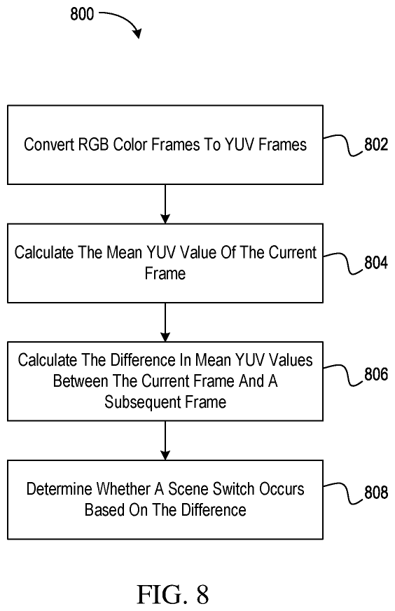

FIG. 8 provides another example method 800 for detecting a scene change. At step 802, the method 800 includes converting RGB color frames to YUV frames. At step 804, the method 800 includes calculating the mean YUV value of the current frame. For example, the mean YUV of the current frame is determined according to Equations 9-11:

$${mean}_{t} ( Y ) = \frac{1}{H * W} {\sum }_{h = 0}^{H - 1} {\sum }_{w = 0}^{W - 1} Y ( h , w ) \qquad [ Equation 9 ]$$

$${mean}_{t} ( U ) = \frac{4}{H * W} {\sum }_{h = 0}^{H / 2 - 1} {\sum }_{w = 0}^{W / 2 - 1} U ( h , w ) \qquad [ Equation 10 ]$$

$${mean}_{t} ( V ) = \frac{4}{H * W} {\sum }_{h = 0}^{H / 2 - 1} {\sum }_{w = 0}^{W / 2 - 1} V ( h , w ) \qquad [ Equation 11 ]$$

At step 806, the method 800 includes calculating the difference in the mean YUV values between the current frame and a subsequent frame. For example, the difference between a frame t and a frame t−1 may be calculated using Equation 12:

$${swd}_{t , t - 1}^{2} = {D}_{Y} + {D}_{U} + {D}_{V} \qquad [ Equation 12 ]$$

where:

$${D}_{Y} = \vert {mean}_{t} ( Y ) - {mean}_{t - 1} ( Y ) \vert$$

$${D}_{U} = \vert {mean}_{t} ( U ) - {mean}_{t - 1} ( U ) \vert$$

$${D}_{V} = \vert {mean}_{t} ( V ) - {mean}_{t - 1} ( V ) \vert$$

At step 808, the method 800 includes determining whether a scene change occurs based on the difference. For example, a threshold is then set for detecting the scene change, as provided by Equation 13:

$${C}_{2} ( t ) = \{ \begin{matrix}1 , {swd}_{t , t - 1}^{2} > {th}_{2} \\ 0 , otherwise\end{matrix} \qquad [ Equation 13 ]$$

The value C₂(t) may be the output of the scene switch detection block 306. While the method 800 is described as calculating the difference between the current frame and a previous frame, the method 800 may instead calculate the difference between the current frame and a future frame.

In another instance, multiple history frames or future frames may be analyzed to make the detection of the scene change more robust. In this instance, the mean YUV value of k history frames is provided as:

$$mean ( Y ) = \frac{1}{k} {\sum }_{i = 0}^{i = k} {mean}_{i} ( Y ) \qquad [ Equation 14 ]$$

$$mean ( U ) = \frac{1}{k} {\sum }_{i = 0}^{i = k} {mean}_{i} ( U ) \qquad [ Equation 15 ]$$

$$mean ( V ) = \frac{1}{k} {\sum }_{i = 0}^{i = k} {mean}_{i} ( V ) \qquad [ Equation 16 ]$$

and the relative difference is provided as:

$${swd}_{t}^{3} = \frac{{D}_{Y}}{mean ( Y )} + \frac{{D}_{U}}{mean ( U )} + \frac{{D}_{V}}{mean ( V )} \qquad [ Equation 17 ]$$

In this instance, the threshold may set as provided by Equation 18:

$${C}_{3} ( t ) = \{ \begin{matrix}1 , {swd}_{t}^{3} > {th}_{3} \\ 0 , otherwise\end{matrix} \qquad [ Equation 18 ]$$

In some implementations, a scene change is detected using a combination of the parameters C₁(t), C₂(t), and C₃(t) and their corresponding thresholds. For example, a scene change may be detected when C₁(t)=1, C₂(t)=1, and C₃(t)=1. In other instances, a scene change is detected when at least two of C₁(t), C₂(t), and C₃(t)=1. In this implementation, the scene switch detection block 306 may effectively detect soft handoffs, such as ablation, fade in, and fade out, as well as abrupt scene handoff detection with minimum additional computational complexity. As one example of potential threshold values for scene detection, th₁=2500, th₂=80, and th₃=0.3.

The outputs of the primary object detection block 304 and the scene switch detection block 306 (e.g., whether a scene change is occurring) are provided to a scene/object classifier block 308. In some instances, the output of the color richness detection block 302 is also provided to the scene/object classifier block 308. The scene/object classifier block 308 identifies classifies the content of the scene, the type of content, and/or the main video objects in the scene captured within the visual frame. In some instances, the frequency at which the scene/object classifier block 308 operates is dependent on the frequency of scene changes. For example, the scene/object classifier block 308 may classify the content of the scene in response to a scene change occurring. In another instance, when no scene changes are detected, the scene/object classifier block 308 operates at a set time interval.

In some instances, the classification results of each visual frame or scene is weighted according to analytics associated with the scene. For example, the color richness value determined by the color richness detection block 302 may be provided to the scene/object classifier block 308 as a weighing value. Scenes of large color richness may be weighed more than scenes with relatively small color richness.

Accordingly, the audio-visual analytic based object rendering system 200 provides a system and process for identifying and classifying objects detected in both visual frames and audio frames. In some implementations, the visual classes are defined to match audio scenes or objects. The visual classes and mapped to the audio classes to create a linked class that defines both the visual frame and the audio frame. For example, speech audio may be linked with a detected face.

The visual processing block 310 receives the classified visual frames and renders the video based on the object classifications. Different classification results may result in different processing strategies. For example, the video processing block 212 and the audio rendering block 218 respectively process video content and audio content for different content types, different scenes, and different objects independently. For example, automatic zooming maybe performed on specific visual objects based on their classification. Different audio processing may be performed on different audio objects based on their classification or categorization, such as leveling, equalization, and spatialization operations. Audio objects categorized as “essential objects” may have their absolute or relative levels boosted (or increased), while audio objects categorized as “low importance objects” may have their absolute or relative levels attenuated (or reduced). Boosting and attenuating audio objects includes adjusting gains associated with the audio objects. In some embodiments, boosting and attenuating audio objects includes increasing or decreasing intelligibility using other forms of audio processing (e.g., dialog enhancement, applying filters, and the like). Additionally, audio and visual objects may be processed based on the scene/object analysis performed at visual scene/object classifier block 206 and audio scene/object classifier block 208. For example, when the visual frame is classified as a forest scene, audio objects associated with insects and bird sounds may be added or increased to improve immersiveness.

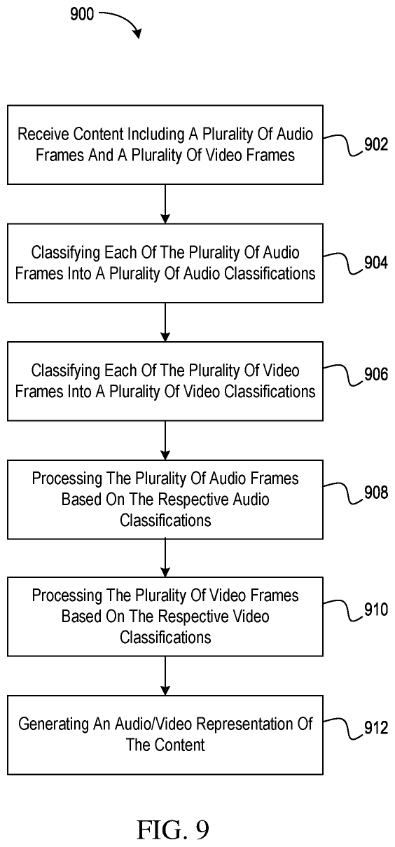

FIG. 9 provides an example method 900 for processing audiovisual content. Various steps described herein with respect to the method 900 are capable of being executed simultaneously, in parallel, or in an order that differs from the illustrated serial and iterative manner of execution. The method 900 may be performed by the post-production block 115. At block 902, the method 900 includes receiving content including a plurality of audio frames and a plurality of video frames. For example, the audio-visual analytic based object rendering system 200 receives video input. The plurality of audio frames are extracted from the video input by audio frames extraction block 204. The plurality of video frames are extracted by visual frames extraction block 202.

At block 904, the method 900 includes classifying each of the plurality of audio frames into a plurality of audio classifications. For example, the audio scene/object classifier block 208 receives the audio frames from audio frames extraction block 204 and classifies the audio frames as audio objects. Classification of the audio frames may be performed by the audio scene/object classifier block 208 in conjunction with the audio object separation block 214 and/or the object selection/metadata generation block 216. Each audio frame includes metadata indicating a classification of the detected audio objects. At block 906, the method 900 includes classifying each of the plurality of video frames into a plurality of video classifications. For example, the visual scene/object classifier block 206 receives the video frames from visual frames extraction block 202 and classifies objects (for example, a detected primary object) within the video frames. Each video frame includes metadata indicating a classification of the detected visual objects.

At block 908, the method 900 includes processing the plurality of audio frames based on the respective audio classifications. For example, the audio rendering block 218 processes the audio frames based on the classifications and categorizations of the audio frames. In some implementations, each audio frame is processed with a different audio processing operation. In other implementations, some audio frames may be processed with the same audio processing operations, while other audio frames are processed with different audio processing operations. For example, a first set of audio frames is processed with a first audio processing operation, a second set of audio frames is processed with a second audio processing operation, and a third set of audio frames is processed with a third audio operation.

At block 910, the method 900 includes processing the plurality of video frames based on the respective video classifications. For example, the visual processing block 212 processes the video frames based on the classifications of visual objects within the video frames. In some implementations, each video frame is processed with a different video processing operation. In other implementations, some video frames may be processed with the same video processing operations, while other video frames are processed with different video processing operations. For example, a first set of video frames is processed with a first video processing operation, a second set of video frames is processed with a second video processing operation, and a third set of video frames is processed with a third video operation.

At block 912, the method 900 includes generating an audio/video representation of the content. For example, the audio visual synthesis block 220 generates a video output by merging the processed plurality of audio frames from the audio rendering block 218 and the processed plurality of video frames from the visual processing block 212.

Systems, methods, and devices in accordance with the present disclosure may take any one or more of the following configurations.
(1) A method of processing audiovisual content, comprising: receiving content including a plurality of audio frames and a plurality of video frames; classifying each of the plurality of audio frames into a plurality of audio classifications; classifying each of the plurality of video frames into a plurality of video classifications; processing the plurality of audio frames based on the respective audio classifications, wherein each audio classification is processed with a different audio processing operation; processing the plurality of video frames based on the respective video classifications, wherein each video classification is processed with a different video processing operation; and generating an audio/video representation of the content by merging the processed plurality of audio frames and the processed plurality of video frames.
(2) The method according to (1), further comprising: categorizing each of the plurality of audio classifications into one of a plurality of priority categories, wherein processing the plurality of audio frames includes processing the plurality of audio frames based on the respective priority category.
(3) The method according to (2), wherein the plurality of priority categories includes a first category and a second category, the first category indicating higher priority than the second category, and wherein processing the plurality of audio frames includes performing at least one selected from the group consisting of boosting audio frames categorized as the first category and attenuating audio frames categorized as the second category.
(4) The method according to (3), wherein the first category includes speech objects.
(5) The method according to (4), wherein the first category further includes objects having height information.
(6) The method according to any one of (4) to (5), wherein the second category does not include speech objects.
(7) The method according to any one of (3) to (6), wherein the plurality of priority categories includes a third category indicating lower priority than the first category, and wherein processing the plurality of audio frames includes attenuating audio frames categorized as the third category at a different level of attenuation than audio frames categorized as the second category.
(8) The method according to any one of (1) to (7), further comprising: extracting, from the content, the plurality of audio frames to separate the plurality of audio frames from the plurality of video frames.
(9) The method according to any one of (1) to (8), further comprising: determining, for each video frame, a color richness of the color frame; comparing, for each video frame, the color richness to a color richness threshold; and discarding, for each video frame and in response to the color richness being less than the color richness threshold, the video frame.
(10) The method according to (9), further comprising: determining, for each video frame, a weight value the video frame based on the color richness of the video frame, wherein each of the plurality of video frames are classified based on the weight value.
(11) The method according to any one of (1) to (10), further comprising: determining whether a scene change occurs between a current video frame and a subsequent video frame, wherein classifying each of the plurality of video frames into a plurality of video classifications includes classifying, for each video frame, the video frame in response to determining a scene change has occurred.
(12) The method according to (11), wherein determining whether a scene change occurs includes: converting the current frame to a first luminance-chrominance-chrome (YUV) frame; converting the subsequent frame to a second YUV frame; generating a first histogram based on the first YUV frame; generating a second histogram based on the second YUV frame; and determining whether the scene change occurs based on the first histogram and the second histogram.
(13) The method according to (12), wherein determining whether the scene change occurs based on the first histogram and the second histogram includes: calculating an absolute sum difference between the first histogram and the second histogram; and comparing the absolute sum difference to a scene change threshold.
(14) The method according to (11), wherein determining whether a scene change occurs includes: converting the current frame to a first luminance-chrominance-chrome (YUV) frame; converting the subsequent frame to a second YUV frame; calculating a difference between a first mean YUV value of the first YUV frame and a second mean YUV value of the second YUV frame; and determining whether the scene change occurs based on the difference between the first mean YUV value and the second mean YUV value.
(15) The method according to any one of (1) to (14), wherein classifying each of the plurality of video frames into a plurality of video classifications includes: performing at least one of a primary object detection and a scene detection to generate an intermediate result; and classifying the plurality of video frames based on the intermediate result.
(16) A non-transitory computer-readable medium storing instructions that, when executed by an electronic processor, cause the electronic processor to perform operations comprising the method according to any one of (1) to (15).
(17) A video system for processing audiovisual content, the system comprising: a processor to perform processing of audiovisual content, the processor configured to: receive content including a plurality of audio frames and a plurality of video frames; classify each of the plurality of audio frames into a plurality of audio classifications; classify each of the plurality of video frames into a plurality of video classifications; process the plurality of audio frames based on the respective audio classifications, wherein each audio classification is processed with a different audio processing operation; process the plurality of video frames based on the respective video classifications, wherein each video classification is processed with a different video processing operation; and generate an audio/video representation of the content by merging the processed plurality of audio frames and the processed plurality of video frames.
(18) The system according to (17), wherein the processor is further configured to: categorize each of the plurality of audio classifications into one of a plurality of priority categories, wherein, to process the plurality of audio frames, the processor is configured to process the plurality of audio frames based on the respective priority category.
(19) The system according to (18), wherein the plurality of priority categories includes a first category and a second category, the first category indicating higher priority than the second category, and wherein, to process the plurality of audio frames, the processor is configured to: boost audio frames categorized as the first category; and attenuate audio frames categorized as the second category.
(20) The system according to any one of (17) to (19), wherein the processor is further configured to: extract from the content, the plurality of audio frames to separate the plurality of audio frames from the plurality of video frames.
(21) The system according to any one of (17) to (20), wherein the processor is further configured to: determine, for each video frame, a color richness of the color frame; compare, for each video frame, the color richness to a color richness threshold; and discard, for each video frame and in response to the color richness being less than the color richness threshold, the video frame.
(22) The system according to any one of (17) to (21), wherein the processor is further configured to: determine whether a scene change occurs between a current video frame and a subsequent video frame, wherein, to classify each of the plurality of video frames into a plurality of video classifications, the processor is configured to classify, for each video frame, the video frame in response to determining a scene change has occurred.
(23) The system according to (22), wherein, to determine whether a scene change occurs, the processor is configured to: convert the current frame to a first luminance-chrominance-chrome (YUV) frame; convert the subsequent frame to a second YUV frame; generate a first histogram based on the first YUV frame; generate a second histogram based on the second YUV frame; and determine whether the scene change occurs based on the first histogram and the second histogram.
(24) The system according to (23), wherein, to determine whether the scene change occurs based on the first histogram and the second histogram, the processor is configured to: calculate an absolute sum difference between the first histogram and the second histogram; and compare the absolute sum difference to a scene change threshold.
(25) The system according to (22), wherein, to determine whether a scene change occurs, the processor is configured to: convert the current frame to a first luminance-chrominance-chrome (YUV) frame; convert the subsequent frame to a second YUV frame; calculate a difference between a first mean YUV value of the first YUV frame and a second mean YUV value of the second YUV frame; and determine whether the scene change occurs based on the difference between the first mean YUV value and the second mean YUV value.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

Some embodiments may be implemented as circuit-based processes, including possible implementation on a single integrated circuit.

Aspects of the systems described herein may be implemented in an appropriate computer-based sound processing network environment for processing digital or digitized audio files. Portions of the adaptive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third.” etc., to refer to an object of a plurality of like objects merely indicates that different instances of such like objects are being referred to, and is not intended to imply that the like objects so referred—to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting.” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also, for purposes of this description, the terms “couple,” “coupling.” “coupled.” “connect,” “connecting.” or “connected” refer to any manner known in the art or later developed in which energy is allowed to be transferred between two or more elements, and the interposition of one or more additional elements is contemplated, although not required. Conversely, the terms “directly coupled.” “directly connected,” etc., imply the absence of such additional elements.

As used herein in reference to an element and a standard, the term compatible means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

“BRIEF SUMMARY OF SOME SPECIFIC EMBODIMENTS” in this specification is intended to introduce some example embodiments, with additional embodiments being described in “DETAILED DESCRIPTION” and/or in reference to one or more drawings. “BRIEF SUMMARY OF SOME SPECIFIC EMBODIMENTS” is not intended to identify essential elements or features of the claimed subject matter, nor is it intended to limit the scope of the claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

1. A method of processing audiovisual content, comprising:
receiving content including a plurality of audio frames and a plurality of video frames;
classifying each of the plurality of audio frames into a plurality of audio classifications;
classifying each of the plurality of video frames into a plurality of video classifications;
processing the plurality of audio frames based on the respective audio classifications, wherein each audio classification is processed with a different audio processing operation;
processing the plurality of video frames based on the respective video classifications, wherein each video classification is processed with a different video processing operation; and
generating an audio/video representation of the content by merging the processed plurality of audio frames and the processed plurality of video frames.

2. The method of claim 1, further comprising:
categorizing each of the plurality of audio classifications into one of a plurality of priority categories, wherein processing the plurality of audio frames includes processing the plurality of audio frames based on the respective priority category.

3. The method of claim 2, wherein the plurality of priority categories includes a first category and a second category, the first category indicating higher priority than the second category, and wherein processing the plurality of audio frames includes performing at least one selected from the group consisting of boosting audio frames categorized as the first category and attenuating audio frames categorized as the second category.

4. The method of claim 3, wherein the first category includes speech objects or objects having height information.

5. (canceled)

6. The method of claim 4, wherein the second category does not include speech objects.

7. The method of claim 3, wherein the plurality of priority categories includes a third category indicating lower priority than the first category, and wherein processing the plurality of audio frames includes attenuating audio frames categorized as the third category at a different level of attenuation than audio frames categorized as the second category.

8. The method of claim 1, further comprising:
extracting, from the content, the plurality of audio frames to separate the plurality of audio frames from the plurality of video frames.

9. The method of claim 1, further comprising:
determining, for each video frame, a color richness of the color frame;
comparing, for each video frame, the color richness to a color richness threshold; and
discarding, for each video frame and in response to the color richness being less than the color richness threshold, the video frame.

10. (canceled)

11. The method of claim 1, further comprising:
determining whether a scene change occurs between a current video frame and a subsequent video frame,
wherein classifying each of the plurality of video frames into a plurality of video classifications includes classifying, for each video frame, the video frame in response to determining a scene change has occurred.

12. The method of claim 11, wherein determining whether a scene change occurs includes:
converting the current frame to a first luminance-chrominance-chrome (YUV) frame;
converting the subsequent frame to a second YUV frame;
generating a first histogram based on the first YUV frame;
generating a second histogram based on the second YUV frame; and
determining whether the scene change occurs based on the first histogram and the second histogram.

13. (canceled)

14. The method of claim 11, wherein determining whether a scene change occurs includes:
converting the current frame to a first luminance-chrominance-chrome (YUV) frame;
converting the subsequent frame to a second YUV frame;
calculating a difference between a first mean YUV value of the first YUV frame and a second mean YUV value of the second YUV frame; and
determining whether the scene change occurs based on the difference between the first mean YUV value and the second mean YUV value.

15. (canceled)

16. A non-transitory computer-readable medium storing instructions that, when executed by an electronic processor, cause the electronic processor to perform operations comprising the method of claim 1.

17. A video system for processing audiovisual content, the system comprising:
a processor to perform processing of audiovisual content, the processor configured to:
receive content including a plurality of audio frames and a plurality of video frames;
classify each of the plurality of audio frames into a plurality of audio classifications;
classify each of the plurality of video frames into a plurality of video classifications;
process the plurality of audio frames based on the respective audio classifications, wherein each audio classification is processed with a different audio processing operation;
process the plurality of video frames based on the respective video classifications, wherein each video classification is processed with a different video processing operation; and
generate an audio/video representation of the content by merging the processed plurality of audio frames and the processed plurality of video frames.

18. The system of claim 17, wherein the processor is further configured to:
categorize each of the plurality of audio classifications into one of a plurality of priority categories, wherein, to process the plurality of audio frames, the processor is configured to process the plurality of audio frames based on the respective priority category.

19. The system of claim 18, wherein the plurality of priority categories includes a first category and a second category, the first category indicating higher priority than the second category, and wherein, to process the plurality of audio frames, the processor is configured to:
boost audio frames categorized as the first category; and
attenuate audio frames categorized as the second category.

20. The system of claim 17, wherein the processor is further configured to:
extract from the content, the plurality of audio frames to separate the plurality of audio frames from the plurality of video frames.

21. The system of claim 17, wherein the processor is further configured to:
determine, for each video frame, a color richness of the color frame;
compare, for each video frame, the color richness to a color richness threshold; and
discard, for each video frame and in response to the color richness being less than the color richness threshold, the video frame.

22. The system of claim 17, wherein the *processor is further configured to:
determine whether a scene change occurs between a current video frame and a subsequent video frame,
wherein, to classify each of the plurality of video frames into a plurality of video classifications, the processor is configured to classify, for each video frame, the video frame in response to determining a scene change has occurred.

23. The system of claim 22, wherein, to determine whether a scene change occurs, the processor is configured to:
convert the current frame to a first luminance-chrominance-chrome (YUV) frame;
convert the subsequent frame to a second YUV frame;
generate a first histogram based on the first YUV frame;
generate a second histogram based on the second YUV frame; and
determine whether the scene change occurs based on the first histogram and the second histogram.

24. (canceled)

25. The system of claim 22, wherein, to determine whether a scene change occurs, the processor is configured to:
convert the current frame to a first luminance-chrominance-chrome (YUV) frame;
convert the subsequent frame to a second YUV frame;
calculate a difference between a first mean YUV value of the first YUV frame and a second mean YUV value of the second YUV frame; and
determine whether the scene change occurs based on the difference between the first mean YUV value and the second mean YUV value.
